(19) United States
(12) Patent Application Publication
(10) Pub. No.: US 2023/0374640 A1
(43) Pub. Date: Nov. 23, 2023

(54) HIGH TRANSFER EFFICIENCY APPLICATION METHODS FOR LOW TEMPERATURE CURING COATING COMPOSITIONS AND COATED SUBSTRATES FORMED THEREBY

(71) Applicant: PPG Industries Ohio, Inc., Cleveland, OH (US)

(72) Inventor: David R. Fenn, Allison Park, PA (US)

(73) Assignee: PPG Industries Ohio, Inc., Cleveland, OH (US)

(21) Appl. No.: 18/247,935

(22) PCT Filed: Oct. 4, 2021
(86) PCT No.: PCT/US2021/053303

§ 371 Date: Apr. 5, 2023

Related U.S. Application Data
(60) Provisional application No. 63/087,550, filed on Oct. 5, 2020.

(51) Int. Cl. C23C 4/04; C09D 7/20; C09D 167/00; C23C 4/18

(52) U.S. Cl. CPC C23C 4/04; C09D 7/20; C09D 167/00; C23C 4/18

(57) ABSTRACT

Methods and compositions for forming a coating layer on a substrate that include a) applying an aqueous coating composition to at least a portion of the substrate using a high transfer efficiency applicator that expels the coating composition; and b) curing the coating composition to form a cured coating layer. The aqueous coating composition includes an aqueous carrier, a film-forming resin having at least one crosslinking-functional group, and a co-reactive material having at least one functional group reactive with the crosslinking-functional group. The cured coating layer of the aqueous coating composition achieves 100 MEK double rubs as measured in accordance with ASTM D5402-19 (2019) after baking at 80° C. for 30 minutes at coating thickness of 35 gm.

### CROSS-REFERENCE TO RELATED APPLICATION

This application claims the benefit of priority of U.S. Provisional Application 63/087,550, filed Oct. 5, 2020, under 35 U.S.C. 119, titled “High Transfer Efficiency Application Methods for Low Temperature Curing Coating Compositions and Coated Substrates Formed Thereby” which is incorporated herein by reference.

### FIELD

The present disclosure relates to methods for high transfer efficiency application of coating compositions to a substrate. More particularly, it relates to high transfer efficiency coating methods that include forming a coating by applying to a substrate an aqueous coating composition in one or multi components.

### BACKGROUND

Coating compositions may be applied to a wide variety of substrates using high transfer efficiency applicator devices with little or no overspray, thereby eliminating the need for masking materials and multiple coating applications. Ink jet printing of droplets and valve ejection of jets are examples of high transfer efficiency coating processes. However, the droplets and jets formed in applying coating compositions using high transfer efficiency devices have less surface area than atomized coating compositions and do not allow carriers or solvents to evaporate from the coating materials as readily as in with conventional coating methods, such as rotary bell application or air assisted spraying. As an example, in case of droplets, the size is about the same, but the target distance is 10× less so flight time from applicator to substrate is much shorter. Thus, the same coating composition remains less viscous after application using a high transfer efficiency applicator than it would be after application by conventional coating methods. The problem is compounded in coating large objects or heavy mass parts having vertical surfaces, such as aircraft fuselages, where coatings tend to sag after application. Nevertheless, it is just the case in coating such large objects and heavy mass parts where the use of masking or overspray containment methods is impracticable and high transfer efficiency applicators are most needed.

### SUMMARY

Provided herein are methods and compositions for forming a coating layer on a substrate that includes a) applying an aqueous coating composition to at least a portion of the substrate using a high transfer efficiency applicator that expels the coating composition; and b) curing the coating composition to form a cured coating layer. The aqueous coating composition includes an aqueous carrier, a film-forming resin having at least one crosslinking-functional group, and a co-reactive material having at least one functional group reactive with the crosslinking-functional group. The cured coating layer of the aqueous coating composition achieves 100 MEK double rubs as measured in accordance with ASTM D5402-19 (2019) after baking at 80° C. for 30 minutes at coating thickness of 35 μm.

### DETAILED DESCRIPTION

Unless otherwise indicated, conditions of temperature and pressure are ambient temperature (22° C.), a relative humidity of 30%, and standard pressure of 101.3 kPa (1 atm).

Unless otherwise indicated, any term containing parentheses refers, alternatively, to the whole term as if parentheses were present and the term without them, and combinations of each alternative. Thus, as used herein the term, “(meth)acrylate” and like terms is intended to include acrylates, methacrylates and their mixtures.

It is to be understood that this disclosure may assume various alternative variations and step sequences, except where expressly specified to the contrary. Accordingly, unless indicated to the contrary, the numerical parameters set forth in the following specification and attached claims are approximations that can vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

All ranges are inclusive and combinable. For example, the term “a rheology modifier in an amount of up to 20 wt. % of the total solids of a coating composition, or from 0.01 to 10, alternatively from 0.05 to 5, or alternatively from 0.05 to 0.1, wt. %, based on the total weight of the coating composition” would include each of from 0.01 to 20 wt. %, from 0.01 to 10 wt. %, from 0.01 to 5 wt. %, from 0.01 to 0.1 wt. %, from 0.01 to 0.05 wt. %, from 0.05 to 0.1 wt. %, from 0.05 to 5 wt. %, from 0.05 to 10 wt. %, from 0.05 to 20 wt. %, from 0.1 to 20 wt. %, from 0.1 to 10 wt. %, from 0.1 to 5 wt. %, from 5 to 20 wt. %, from 5 to 10 wt. %, or from 10 to 20 wt. %. Further, when ranges are given, any endpoints of those ranges or numbers recited within those ranges can be combined within the scope of the present disclosure.

As used herein, unless otherwise expressly specified, all numbers such as those expressing values, ranges, amounts or percentages can be read as if prefaced by the word “about”, even if the term does not expressly appear. Unless otherwise stated, plural encompasses singular and vice versa. As used herein, the term “including” and like terms means “including but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a coating layer “formed over” a substrate does not preclude the presence of other coating layers of the same or different composition located between the formed coating layer and the substrate.

As used herein, the terms “a” and “an” shall be construed to include “at least one” and “one or more”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

Provided herein are coating compositions that can rapidly develop increased viscosity upon application to a substrate after being applied using high transfer efficiency applicator devices for coatings. Thus, methods are provided herein for high transfer efficiency coating that enable the provision of coatings that give an acceptably small degree of sag when applied to vertical surfaces.

The methods in accordance with the present disclosure enable provision of an aqueous coating composition that, upon application to a substrate, forms a coating layer that exhibits a 60 wt. % or higher dehydration or loss of volatiles when applied to a metal foil at thickness of 35 μm, after a 2-minute dehydration bake at 65° C. For example, the coating layer comprising the aqueous coating compositions of the present disclosure achieves at least a 60 wt. % loss of volatiles or, at least a 70 wt. % loss of volatiles, or at least an 80 wt. % loss of volatiles, or at least a 90 wt. % loss of volatiles after the 2-minute dehydration bake at 65° C., as compared to the volatiles content of the aqueous coating composition prior to application.

In accordance with the present disclosure, suitable aqueous coating compositions for use with high transfer efficiency applicators exhibit rapid curing, rapid dehydration, or both. The compositions may further exhibit non-Newtonian fluid behavior, which is in contrast to conventional ink. Suitable aqueous coating compositions of the present disclosure, when applied to the substrate using a high transfer efficiency applicator form a coating layer that may have precise boundaries, improved hiding, or reduced drying time. The coating compositions when applied and cured form a coating layer on the substrate. The aqueous coating compositions may be one useful to form any of a basecoat, a clearcoat, a color coat, a top coat, a single-stage coat, a primer coat, a sealer coat, or combinations thereof, on a substrate, or another cured or uncured coating layer. For example, the coating composition may form a basecoat coating layer.

In accordance with the methods of the present disclosure, the aqueous coating composition may be in the form of a one component or “1 K” composition or a multi-component composition, such as a two component “2 K” composition. The aqueous coating composition may comprise (i) a two-component composition wherein one component comprises an aqueous dispersion of a hydroxyl functional material as the film-forming resin and the other component comprises an aqueous dispersion of an isocyanate functional material as the co-reactive material, (ii) a two-component composition wherein one component comprises a carboxyl functional material as the film-forming resin and the other component comprises a carbodiimide functional material as the co-reactive material, (iii) a one component composition of a carboxyl functional material as the film-forming resin and a carbodiimide functional material as the co-reactive material, (iv) a one component composition of a polymer as the film-forming resin having an acid value of at least 15 obtained from greater than 20 wt. % of a polytetrahydrofuran and greater than 5 wt. % of a carboxylic acid or anhydride, based on the weight of reactants used to form the polymer, and a melamine resin as the co-reactive material comprising imino and methylol functional groups that together comprise 30 mole % or greater of the total functionality of the melamine resin, (v) a one component composition of a keto functional polymer as the film-forming resin and a polyhydrazide or a hydrazide functional polymer as the co-reactive material; or (vi) mixtures of two or more of any of (i), (ii), (iii) (iv) and (v). In the (i) two-component aqueous coating compositions applied in accordance with the methods of the present disclosure, one component may comprise a hydroxyl functional material and the other component may comprise an isocyanate functional material having greater than 5 wt. % of free polyisocyanate, i.e., no blocking agent, having a weight average molecular weight of less than 600 g/mol.

In accordance with the methods of the present disclosure, the aqueous coating composition may further include a polyester film-forming resin.

In accordance with the methods of the present disclosure, the aqueous coating composition may further comprise, or each of the film-forming resin and co-reactive material of a two-component aqueous composition may further comprise rheology modifiers, swelling solvents that cause at least part of the film-forming resin to swell and expand, or both of them. The rheology modifier may comprise an inorganic thixotropic agent, an acrylic alkali swellable emulsion (ASE), a hydrophobically-modified alkali swellable emulsion (HASE), a hydrophobically modified ethylene oxide urethane block copolymer (HEUR), an associative thickener other than a HEUR, hydrophobically-modified hydroxy ethyl cellulose (HMHEC), cellulosic thickeners other than HMHEC, polyvinyl alcohol, polyvinyl pyrrolidone, polyvinyl methylether, polyethylene oxide, polyacrylamide, ethylene vinyl acetate copolymer wax, polyamides, polyacrylic acid, mixtures thereof, or combinations thereof. The amount of rheology modifier may range from 0.05 to 20 wt. % of the total film-forming resin solids of the coating composition. The swelling solvent may comprise alkyl ethers, glycol ethers, hydrophobic group containing alcohols, hydrophobic group containing ketones, alkyl esters, alkyl phosphates and mixtures thereof. In accordance with the methods of the present disclosure, the film-forming resin of the aqueous coating composition may be dispersed as particles in the aqueous carrier and the composition may further comprise the swelling solvent that may cause the particles of the solvent swellable film-forming resin to swell and expand prior to curing.

In the case of a two-component aqueous composition, the ratio of the viscosity at 25° C. and a pressure of 101.3 kPa (1 atm) of each of the film-forming resin and the co-reactive material prior to the mixing may range from 2:1 to 1:2. Viscosity of an aqueous coating composition is measured by a BYK CAP 2000+ Viscometer with Spindle #4 at a shear rate of 1000 s−1 at 20° C.

In accordance with the compositions and methods of the present disclosure, the aqueous coating composition can have a rheology profile at 25° C. and a pressure of 101.3 kPa (1 atm) defined as the ratio of the viscosity at a shear rate of 0.1 s⁻¹ to the viscosity at a shear rate of 1000 s−1 as measured using a BYK CAP 2000+ Viscometer with Spindle #4 of from at least 25:1, such as 50:1 and 100:1 and can be up to a ratio of 350:1, such as 300:1, and 250:1. As nonlimiting examples, the viscosity ratio can be from 25:1 to 350:1, such as 25:1 to 300:1, 50:1 to 350:1, 100:1 to 350:1 and 25:1 to 250:1. The aqueous coating compositions can have an ambient viscosity ranging from 7 to 100 Pa*s, such as 10 to 100 Pa*s at a shear stress of 1 Pa and have an ambient viscosity ranging from 0.03 to 1 Pa*s, such as 0.1 to 1 Pa*s at a shear stress of 10 Pa.

In accordance with the methods of the present disclosure, the solids content of the aqueous coating composition may range from 10 to 80 wt. %, based on the total weight of the coating composition. In the methods, the high transfer efficiency applicator may comprise a valve jet applicator having one or more nozzle openings, each of which discharges the aqueous coating composition in the form of a coherent coating composition jet. Alternatively, in the methods, the high transfer efficiency applicator may comprise a printhead having one or more nozzle openings, each of which discharges the aqueous coating composition in the form of a droplet.

In accordance with the methods of the present disclosure, the aqueous coating composition may be a pigmented coating composition such as a pigmented basecoat coating composition. The methods may further comprise applying a primer layer or a pigmented basecoat layer on the substrate prior to applying the pigmented basecoat coating composition to at least a portion of the substrate using a high transfer efficiency applicator. The methods may further comprise forming a clearcoat coating layer by applying a clearcoat coating composition over at least a portion of the basecoat layer using a high transfer efficiency applicator. For the avoidance of doubt, in the disclosed methods, any layer can be conventionally applied as long as at least one layer of the multiple coating layers is applied using a high transfer efficiency applicator.

In accordance with the methods of the present disclosure, the substrate may or may not be masked with a removable material. In accordance with the methods of the present disclosure, the substrate may have a vertical portion and the coating layer may be formed on the vertical portion of the substrate.

In the case of a two-component aqueous composition, the methods of the present disclosure may comprise mixing together the two components of a two-component aqueous coating composition prior to applying the aqueous coating composition.

The present disclosure provides a substrate coated by the methods in accordance with the present disclosure. The substrate may be coated by the methods of forming a coating layer comprising applying to at least a portion of the substrate an aqueous coating composition comprising an aqueous carrier, a film-forming resin having at least one crosslinking-functional group, and a co-reactive material having at least one functional group reactive with the crosslinking-functional group by use of a high transfer efficiency applicator that expels the coating composition. The coated substrate may bear a cured coating layer. The cured coating layer in accordance with the present disclosure having a thickness of 35 μm may achieve 100 MEK double rubs as measured according to ASTM D5402-19 (2019) after baking at 80° C. for 30 minutes. The substrate may be a vehicle, a portion thereof or a vehicle part. Further, the substrate may have a vertical portion and the coating layer may be formed on the vertical portion of the substrate. Still further, the substrate may not be masked with a removable material in the methods in accordance with the present disclosure and may bear the coating layer formed on a portion of the substrate that defines a target area having a discrete boundary outside of which the substrate does not have the coating layer.

As used herein, the term “addition polymerization product” refers to an initiation polymerization product of a mixture of (multi)ethylenically unsaturated monomers, such as an aqueous emulsion polymer. Addition polymerization takes place by conventional methods. The ethylenically unsaturated monomers may include, for example, acrylic, vinyl or allyl monomers.

As used herein, the term “aqueous” refers to a carrier or solvent wherein the solvent comprises water and up to 50 wt. % of water miscible organic solvents, such as alkyl ethers.

As used herein, the term “ASTM” refers to publications of ASTM International, West Conshohocken, PA.

As used herein, the term “basecoat” refers to a coating layer that provides protection, color, hiding (also known as “opacity”) or visual appearance. The term “basecoat coating composition” refers to a coating composition that contains colorants and that can be used to form a basecoat.

As used herein, the term “coating” refers to the finished product resulting from applying coating compositions to a substrate and forming the coating, such as by curing. A primer layer, pigmented basecoat or color coat layer and clear coat layer may all be coatings, and any of these coatings can be formed in accordance with the methods of the present disclosure. As used herein, the term “coating layer” is used to refer to the result of applying coating compositions on a substrate in one or more applications of the coating compositions and curing the coating compositions.

As used herein, the term “crosslinking-functional group” refers to functional groups that are positioned in the backbone of a polymer, in a group pendant from the backbone of the polymer, terminally positioned on the backbone of the polymer, or combinations thereof, wherein such functional groups are capable of reacting with themselves, other crosslinking-functional groups or with a separate co-reactive material during curing to produce a crosslinked coating.

As used herein, the term “film-forming” materials refer to film-forming constituents of a coating composition and can include resins, co-reactive materials, crosslinking materials, or any combination thereof that are film-forming constituents of the coating composition. Film-forming materials may be cured by baking, such as at least at 60° C. or 80° C., or in conditions of 22° C. and 101.3 kPa (1 atm).

As used herein, the term “hydrophilic group” refers to a moiety that has an affinity for water or capable of interacting with water as a nonlimiting example interacting through hydrogen bonding.

As used herein, the term “hydrophobic group” refers to a hydrocarbon or (alkyl)aromatic group, or an alkyl group have 4 or more carbon atoms. And, as used herein, the term “hydrophobic group containing alcohols” and “hydrophobic group containing ketones” means that that alcohol or ketone contains an (alkyl)aromatic group, or an alkyl group have 4 or more carbon atoms.

Unless otherwise indicated, as used herein, the term “molecular weight” refers to a weight average molecular weight as determined by gel permeation chromatography (GPC) using appropriate polystyrene standards. If a number average molecular weight is specified, the weight is determined in the same GPC manner, while calculating a number average from the thus obtained polymer molecular weight distribution data.

As used herein, the term “nozzle” refers to an opening, including an orifice, through which a coating composition is ejected or jetted and, unless otherwise indicated, the term “nozzle” can include any of a valve jet, or piezo-electric, thermal, acoustic, pneumatic or ultrasonic actuated valve jet or nozzle. The terms “nozzle opening” and “orifice” are used interchangeably.

As used herein, the term “one component” or “1 K” composition refers to a composition wherein all the coating components are maintained in the same container after manufacture, during storage, etc. In contrast, a multi-component composition, such as a two component “2K” composition has at least two components that are maintained in a different container after manufacture, during storage, etc. prior to application and formation of a coating layer.

As used herein, the term “phr” refers to the amount of a given material based on one hundred weight parts of resin in a given composition.

As used herein, the term “polymer” includes homopolymers and copolymers that are formed from two or more different monomer reactants or that comprise two or more distinct repeat units. Further, the term “polymer” includes prepolymers, and oligomers and is defined in accordance with the Compendium of Polymer Terminology and Nomenclature: IUPAC Recommendations, 2008, Royal Society of Chemistry (ISBN 978 0 85404 491 7).

As used herein, the term “resin” includes any film-forming polymer or other film-forming material.

As used herein, the term “substrate” refers to an article surface to be coated; an article to which coating layers have already been applied is also considered a substrate.

As used herein, the term “target area” means a portion of the surface area of any substrate that can be coated in applying any one coating composition, such as a first, a second or a third coating composition. The target area may exclude nearly the entire surface area of a given substrate. The term “non-target area” means the remainder of the surface area of the substrate to which a coating composition is not applied. In applying multiple coating compositions, for each application of one coating composition, the target area and non-target areas may differ.

As used herein, the term “swelling solvent” refers to a solvent that interacts with a film-forming resin causing it to swell and expand. The swelling solvent used with the aqueous coating composition of the present disclosure can be an organic solvent. The swelling solvent used in accordance with the present disclosure can cause the low shear viscosity of a composition comprising the film-forming resin, as measured by a BYK CAP 2000+ Viscometer with Spindle #4 at a shear rate of 0.1 s⁻¹ at 20° C., to increase by at least 20%, or at least 50%, or at least 100%, or at least 500% when added to the film-forming resin at 10 wt. %, based on resin solids.

As used herein, the term “thermosetting or crosslinking” polymer or resin means that a polymer or resin has functional groups that react with a co-reactive material or crosslinking functional group, including itself or another resin, polymer or molecule in cure.

As used herein, the term “total solids” or “solids” refers to the solids content as determined in accordance with ASTM D2369 (2015).

As used herein, the term “uniform droplet or jet distribution” means that 60% or, 70%, or, 80% or more of the droplets or jets by volume have a size within 30%, 25%, 20% or less of the median size of the droplets or jets. For example, as used herein, the nominal median size for a droplet or jet is the diameter of each nozzle opening of the high transfer efficiency applicator.

As used herein, the term “vehicle” is used in its broadest sense and includes all types of vehicles, such as but not limited to cars, mini vans, SUVs (sports utility vehicle), trucks, semi-trucks; tractors, buses, vans, golf carts, motorcycles, bicycles, railroad cars, trailers, ATVs (all-terrain vehicle); pickup trucks; heavy duty movers, such as, bulldozers, mobile cranes and earth movers; aircraft; boats; ships; and other modes of transport. The portion of the vehicle that is coated in accordance with the present disclosure may vary depending on the use or application of the coating. For example, anti-chip primers may be applied to some of the portions of the vehicle. When used as a colored basecoat or monocoat, the present coating compositions may be applied to those portions of the vehicle that are visible such as the roof, hood, doors trunk lid and the like, but may also be applied to other areas such as inside the trunk, inside the door and the like. Clearcoats will typically be applied to the exterior of a vehicle.

As used herein, unless otherwise stated, the term “viscosity” of a given composition is the value as measured by a BYK CAP 2000+ Viscometer with Spindle #4 at a shear rate of 1000 s⁻¹ at 20° C. Unless otherwise indicated, the “viscosity” of a coating layer, prior to flash off or baking, is determined at 25° C. and a pressure of 101.3 kPa (1 atm) using an Anton-Paar MCR301 rheometer equipped with a 50 mm parallel plate-plate fixture with temperature-control and keeping a plate-plate distance fixed at 0.2 mm at a constant stress of 1 Pa.

As used herein, the phrase “wt. %” stands for weight percent.

The present disclosure provides methods comprising applying to a substrate an aqueous coating composition that comprises a film-forming resin having at least one crosslinking-functional group and a co-reactive material having a functional group reactive with the crosslinking-functional group. In accordance with the coating compositions of the present disclosure, the carrier can be aqueous and can be exclusively water. However, it can be desirable to include an amount of up to 200 phr of organic solvents or an amount of solvent that would result in a coating composition having up to 200 g/L of total volatile organic content. Examples of suitable solvents which can be incorporated in the organic content are swelling solvents which swell polymer particles or their compositions, such as alkyl ethers, for example, C₄ or higher alkyl hydrophobic ethers, glycol ethers, like monomethyl or monoethyl ethers of ethylene glycol or diethylene glycol, or for example, C₄ or higher alkyl hydrophobic glycol ethers, like butyl glycol ethers, such as, for example, monobutyl ether of ethylene glycol, monobutyl ethers of diethylene glycol, hydrophobic group containing ketones, like methyl isobutyl ketone and diisobutyl ketone; hydrophobic group containing alcohols, like ethyl hexanol, alkyl esters, such as, for example, acetates like butyl acetate, ethyl acetate, n-butyl acetate, isobutyl acetate, and a combination thereof or other ketones, such as, for example, methyl ethyl ketone, methyl isobutyl ketone, methyl amyl ketone. Swelling solvents used in amounts of up to 200 wt. %, or, 0.5 wt. % or more, or 2 wt. % or more, or, 5 wt. % or more, or, 10 wt. % or more, or, 120 wt. % or less, or, 30 wt. % or less, or, 20 wt. % or less, such as from 0.05 to 200 wt. %, or, for example, from 1 to 120 wt. %, or from 5 to 60 wt. %, or, from 10 to 30 wt. %, based on the weight of the total film-forming resin solids in the coating composition help can provide extensional viscosity and rheology modifying effects in coatings.

The aqueous coating compositions of the present disclosure comprise a film-forming resin and a co-reactive material, wherein the aqueous coating composition can comprise a one-component composition or a two-component composition chosen from (i) a two-component composition wherein one component comprises an aqueous dispersion of a hydroxyl functional material as the film-forming resin and the other component comprises an aqueous dispersion of an isocyanate functional material as the co-reactive material, (ii) a two-component composition wherein one component comprises a carboxyl functional material as the film-forming resin and the other component comprises a carbodiimide functional material as the co-reactive material, (iii) a one component composition of a carboxyl functional material as the film-forming resin and a carbodiimide functional material as the co-reactive material, (iv) a one component composition of a polymer as the film-forming resin having an acid value of at least 15 obtained from greater than 20 wt. % of a polytetrahydrofuran and greater than 5 wt. % of a carboxylic acid or anhydride, based on the weight of reactants used to form the polymer, and a melamine resin as the co-reactive material comprising imino and methylol functional groups that together comprise 30 mole % or greater of the total functionality of the melamine resin, (v) a one component composition of a keto functional polymer as the film-forming resin and a polyhydrazide or a hydrazide functional polymer as the co-reactive material; or (vi) mixtures of two or more of any of (i), (ii), (iii) (iv) and (v).

The aqueous coating compositions of the present disclosure may be chosen from (i) an aqueous two-component polyurethane dispersion of an isocyanate functional material component as the co-reactive material and, separately, of a hydroxyl functional material component as the film-forming resin. Suitable hydroxyl functional material components may include hydroxyl functional polyurethane-acrylate particles dispersed in an aqueous medium and a separate polyisocyanate component having two or more isocyanate groups. The dispersed hydroxyl functional polyurethane-acrylate particles may include the reaction product obtained by polymerizing the reactants of a pre-emulsion formed from an active hydrogen-containing polyurethane acrylate prepolymer that includes a reaction product obtained by reacting a mixture (A) (i) a polyol; (ii) a polymerizable ethylenically unsaturated monomer containing at least one hydroxyl group; (iii) a compound comprising a C₁ to C₃₀ alkyl group having at least two active hydrogen groups selected from carboxylic acid groups and hydroxyl groups, wherein at least one active hydrogen group is a hydroxyl group; and (iv) a polyisocyanate, wherein the stoichiometry is such that the number of available hydroxyl groups in the mixture exceeds the number of the available isocyanate groups. The hydroxyl functional polyurethane-acrylate particles may be internally crosslinked polymeric microgels formed by conventional addition polymerization of multiethylenically unsaturated monomers. The isocyanate functional material component may comprise a polyisocyanate which is not blocked, which is a material comprising free isocyanates.

Examples of suitable useful polyols (i) may be polyols selected from diols, triols, polyetherpolyols, polyesterpolyols, acrylic polyols, such as those formed by reacting acid functional acrylic polymers with diols or triols, or any combinations thereof. A suitable diol may be 1,6-hexanediol, cyclohexanedimethanol, 2-ethyl-1,6-hexanediol, 1,3-propanediol, 1,4-butanediol, neopentyl glycol, or another glycol. A suitable triol may be trimethylol propane, 1,2,6-hexantriol, or glycerol. A suitable polyetherpolyol may be any of poly(oxytetramethylene) glycols; poly(oxyethylene) glycols; or poly(oxy-1,2-propylene) glycols.

Examples of suitable polyisocyanates useful as the isocyanate functional material or as a (iv) polyisocyanate in making an aqueous hydroxyl functional material component dispersion of the present disclosure include aromatic isocyanates, such as 4,4′-diphenylmethane diisocyanate, 1,3-phenylene diisocyanate and toluene diisocyanate, and aliphatic polyisocyanates, such as 1,4-tetramethylene diisocyanate and 1,6-hexamethylene diisocyanate. Diisocyanate condensation products such as isocyanurate, uretdione and biuret can be used. Cycloaliphatic diisocyanates, such as 1,4-cyclohexyl diisocyanate and isophorone diisocyanate also can be employed.

The amount of the polyisocyanate useful as the isocyanate functional material component can comprise at least 15 wt. %, at least 20 wt. %, or at least 25 wt. %, based on the total resin solids weight of the two-component aqueous coating composition. The polyisocyanate can also comprise up to 40 wt. %, or up to 35 wt. %, or up to 30 wt. %, based on the total resin solids weight of the two-component aqueous coating composition. The polyisocyanate can further comprise an amount of, for example, from 15 to 40 wt. %, or from 20 to 30 wt. %, based on the total resin solids weight of the two-component aqueous coating composition. The polyisocyanate may be dispersed or emulsified in an aqueous medium as a solution in a swelling solvent or other solvent in the presence of a suitable surfactant or dispersing agent. The ratio of the viscosity of the aqueous dispersion of the isocyanate functional material to that of the aqueous dispersion of the hydroxyl functional material component ranges less than two or three times that of the polyol component.

The aqueous coating compositions of the present disclosure may comprise (ii) a two-component composition wherein one component comprises a carboxyl functional material as the film-forming resin and the other component comprises a carbodiimide functional material as the co-reactive material or (iii) a one component composition of a carboxyl functional material as the film-forming resin and a carbodiimide functional material as the co-reactive material. In the two-component aqueous coating composition, the carbodiimide functional material may comprise an aliphatic carbodiimide.

Carbodiimide functional co-reactive materials suitable for use in one component aqueous coating composition, may comprise an aromatic carbodiimide or an amount of 10 wt. % or less an aliphatic carbodiimide functional material, based on total resin solids in the aqueous coating composition.

The carboxyl functional material may comprise an addition polymer, such as a vinyl or acrylic copolymer, formed from a monomer mixture containing a monomer such as an alkyl (meth)acrylate, an allyl ester or a vinyl ester, and a carboxylic acid functional monomer or its salt, such as (meth)acrylic acid or sodium acrylate. The amount of the carboxylic acid functional monomer or salt may range from 0.5 to 5 wt. %, or from 0.15 to 0.5 wt. %, or from 0.3 to 0.5 wt. %, based on the total weight of reactants used to make the polymer. Suitable addition polymers are formed by conventional aqueous emulsion polymerization in the presence of an initiator, such as a sulfinic acid or its salt, in the manner known to the ordinary skilled artisan.

The carbodiimide functional material may be formed by self-condensation of a diisocyanate or a triisocyanate, for example, isophorone diisocyanate (1-isocyanato-3-isocyanatomethyl-3,5,5-trimethylcyclohexane), tetramethylxylylene diisocyanate, or any polyisocyanate useful in the making a suitable isocyanate functional material, with loss of carbon dioxide in the presence of a compound bearing a hydroxyl group and a decarboxylation catalyst. The compound bearing a hydroxyl group may be a polyetherpolyol. Carbodiimides may be prepared by the following procedure: a diisocyanate, and a monohydroxyl poly-alkylene oxide (e.g., methanol-terminated polyethylene oxide) are mixed in an aprotic solvent and heated to 100 to 150° C. Then a catalyst, such as 1-methyl-2-phospholen-1-oxide, can be added and the mixture can be heated for several hours at 130 to 160° C. The amount of the carbodiimide in the aqueous coating compositions of the present disclosure may range from 0.1 to 30 wt. %, or, from 0.2 to 20 wt. %, or from 0.1 to 10 wt. %, based on the total weight of resin solids. Examples of suitable polycarbodiimides are those disclosed in US 2011/0070374 to Ambrose et al. and are available as CARBODILITE resins (Nisshinbo Chemical, Inc., Tokyo, JP).

The aqueous coating compositions of the present disclosure may comprise (iv) a one component composition of a polymer as the film-forming resin having an acid value of at least 15 obtained from greater than 20 wt. % of a polytetrahydrofuran, and greater than 5 wt. % of a carboxylic acid or anhydride, based on the weight of reactants used to form the polymer, and a melamine resin as a crosslinking material comprising imino and methylol functional groups that together comprise 30 mole % or greater of the total functionality of the melamine resin. As used herein, the term “acid value” refers to the value in mg KOH/g as determined by titrating with a standardized solution of potassium hydroxide.

Suitable amounts of the polytetrahydrofuran reacted with the carboxylic acid or anhydride to form the polymer that is reactive with the melamine resin can range from greater than 20 wt. %, or greater than 30 wt. %, or greater than 40 wt. %, based on the weight of reactants used to form the polymer. The polytetrahydrofuran can also comprise up to 50 wt. %, or up to 60 wt. %, or up to 70 wt. %, or up to 80 wt. %, or up to 90 wt. %, based on the weight of reactants used to form the polymer. The amount of polytetrahydrofuran may range from 20 to 90 wt. %, or from 40 to 80 wt. %, or from 50 to 70 wt. %, or from 30 to 40 wt. %, based on the weight of reactants used to form the polymer.

The acid functionality of a polymer in accordance with the present disclosure that is reactive with the melamine resin can have a pKa of less than 5, or less than 4, or less than 3.5, or less than 3, or less than 2.5, or less than 2. The acid functionality of the polymer that is reactive with the melamine resin can be within a pKa range such as for example from 1.5 to 4.5. The pKa value is the negative (decadic) logarithm of the acidic dissociation constant and is determined according to the titration method described in Dean, Lange's Handbook of Chemistry, 15th edition, section 8.2.1, McGraw-Hill Educational, 1999.

A suitable carboxylic acid or anhydride can be chosen from di- or poly-carboxylic acids or the anhydrides thereof, such as a dicarboxylic acid or anhydride, a polycarboxylic acid having three or more carboxylic acid groups or its anhydride, or more than one or these. The carboxylic acid or anhydride thereof can be an aromatic or aliphatic acid. The carboxylic acid or anhydride thereof can be selected from compounds having aromatic rings or aliphatic structures. For instance, the carboxylic acid or anhydride thereof can be selected from an aromatic compound in which the carboxylic acid or anhydride functional groups are bonded directly to the aromatic ring(s) such that there are no interrupting atoms between the aromatic ring(s) and the attached carboxylic acid or anhydride functional groups (a non-limiting example being trimellitic anhydride). Non-limiting examples of carboxylic acids include glutaric acid, succinic acid, malonic acid, oxalic acid, trimellitic acid, phthalic acid, isophthalic acid, hexahydrophthalic acid, adipic acid, maleic acid, and combinations thereof. Non-limiting examples of anhydrides include trimellitic anhydride, phthalic anhydride, maleic anhydride, succinic anhydride, malonic anhydride, oxalic anhydride, hexahydrophthalic anhydride, adipic anhydride, and combinations thereof.

The amount of the carboxylic acid or anhydride used to form the polymer that is reactive with the melamine resin co-reactive material of the present disclosure can range from 5 wt. % or more, or 8 wt. % or more of the reactants that form the polymer. Unless otherwise indicated, the amount of carboxylic acid or anhydride can range up to 20 wt. %, or up to 15 wt. %, or up to 12 wt. % of the reactants that form the polymer. The amount of the carboxylic acid or anhydride can range from 5 to 20 wt. %, or from 8 to 15 wt. %, or from 8 to 12 wt. %, or from 7 to 10 wt. % of the reactants that form the polymer.

The polymer reactive with the melamine resin can also be prepared with other materials in addition to polytetrahydrofuran and carboxylic acids or anhydrides thereof. Non-limiting examples of additional materials that can be used to form the polymer include polyols, additional carboxylic acid group or anhydride containing compounds, ethylenically unsaturated compounds, polyisocyanates, and combinations thereof.

Examples of suitable polyols include glycols, polyether polyols, polyester polyols, copolymers thereof, and combinations thereof. Non-limiting examples of glycols include ethylene glycol, diethylene glycol, triethylene glycol, 1,2-propylene glycol, 1,3-butylene glycol, tetramethylene glycol, hexamethylene glycol, and combinations thereof, as well as other compounds that comprise two or more hydroxyl groups and combinations of any of the foregoing. Non-limiting examples of suitable polyether polyols in addition to the polytetrahydrofuran include polyethylene glycol, polypropylene glycol, polybutylene glycol, and combinations thereof. Other suitable polyols include, but are not limited to, cyclohexanedimethanol, 2-ethyl-1,6-hexanediol, 1,3-propanediol, 1,4-butanediol, neopentyl glycol, trimethylol propane, 1,2,6-hexantriol, glycerol, and combinations thereof. The polyols can be selected from diols or from compounds having 3 or more hydroxyl groups.

The polymer film-forming resin that is reactive with the melamine resin can comprise a hydroxyl equivalent weight of from 1500 to 5000, or from 2000 to 3000 g/equivalent, as measured by reacting the dried polymer with an excess amount of acetic anhydride and titrating with potassium hydroxide.

The polymer film-forming resin of the present disclosure that is reactive with the melamine resin comprises at least ether linkages and carboxylic acid functional groups. Thus, the remaining amount of materials used to form the polymer reactive with the melamine resin may include a polyol that is different from the polytetrahydrofuran, another carboxylic acid or anhydride that is different from the first carboxylic acid or anhydride. Further, the polymer that is reactive with the melamine resin can also comprise ester linkages or urethane linkages as well as additional functional groups such as hydroxyl functional groups. For instance, the polymer can comprise ether linkages, ester linkages, carboxylic acid functional groups, and hydroxyl functional groups. The resulting polymer can also comprise additional linkages and functional groups including, but not limited to, the addition functional groups, such as ethylenically unsaturated groups.

The polymer reactive with the melamine resin can comprise polymeric core-shell particles in which the polymeric core is at least partially encapsulated by the polymeric shell, a self-emulsifying dispersion polymer, or a combination thereof. As used herein, the term “self-emulsifying dispersion polymer” refers to a polymer that contains hydrophilic functionality and is not synthesized initially as an aqueous dispersion, and then mixed with water to form an aqueous dispersion. Either stage, the core or the shell of the core-shell particles can be prepared to provide a polymer that forms in water a polymeric shell with enhanced water-dispersibility/stability. Thus, one stage of the multistage or core-shell polymer can comprise water-dispersible groups while the polymeric core can be free of water-dispersible groups, so that, in an aqueous medium, that stage becomes the polymeric shell that at least partially encapsulates the core. The shell of the core-shell particles may be obtained from the polytetrahydrofuran, a carboxylic acid or anhydride thereof, hydroxyl functional ethylenically unsaturated compound(s) and, optionally, other materials, such as additional polyols, additional carboxylic acid or anhydrides, polyisocyanates, or combinations thereof. The polymer that forms the shell can have the previously described characteristics of the polytetrahydrofuran, such as the previously described acid values. Further, the polymeric core may comprise an addition polymer derived from ethylenically unsaturated monomers.

In the shell, the amount of polytetrahydrofuran may range from 20 to 90 wt. %, or from 40 to 80 wt. %, or from 50 to 70 wt. %, or from 55 to 65 wt. % of the reactants that form the polymeric shell.

In the shell of the polymeric core-shell particle film-forming resins of the present disclosure, the amount of carboxylic acid or anhydride can range from 5 to 20 wt. %, or from 8 to 18 wt. %, or from 10 to 16 wt. %, or from 12 to 15 wt. % of the reactants that form the polymeric shell.

The polymeric shell of the polymeric core-shell particle film-forming resins of the present disclosure can be also covalently bonded to at least a portion of the polymeric core. For example, the polymeric shell can be covalently bonded to the polymeric core by reacting at least one functional group on the monomers or prepolymers that are used to form the polymeric shell with at least one functional group on the monomers or prepolymers that are used to form the polymeric core. The functional groups can include any of the functional groups previously described provided that at least one functional group on the monomers or prepolymers that are used to form the polymeric shell can be reactive with at least one functional group on the monomers or prepolymers that are used to form the polymeric core. For instance, the monomers or prepolymers that are used to form the polymeric shell and polymeric core can both comprise at least one ethylenically unsaturated group that are reacted with each other to form a chemical bond. As used herein, a “prepolymer” refers to a polymer precursor capable of further reactions or polymerization by reactive groups to form a higher molecular mass or cross-linked state.

The water-dispersible groups in a self-emulsifying dispersion polymer polymeric core-shell particle film-forming resin of the present disclosure can comprise ionic or ionizable groups such as the carboxylic acid functional groups or salts thereof. The carboxylic acid functional groups can be at least partially neutralized (i.e., at least 30% of the total neutralization equivalent) by a base, such as a volatile amine, to form a salt group. A volatile amine refers as an amine compound having an initial boiling point of less than or equal to 250° C. as measured at a standard atmospheric pressure of 101.3 kPa. Examples of suitable volatile amines are ammonia, dimethylamine, trimethylamine, monoethanolamine, and dimethylethanolamine. The amines will evaporate during the formation of the coating to expose the carboxylic acid functional groups and allow the carboxylic acid functional groups to undergo further reactions. Other non-limiting examples of water-dispersible groups include polyoxyalkylene groups such as by using polyethylene/propylene glycol ether materials for example.

The self-emulsifying dispersion polymer of the present disclosure may be obtained from the previously described materials comprising the polytetrahydrofuran, the carboxylic acid or anhydride or salts thereof, and, optionally, other additional reactants (e.g., additional polyols, additional carboxylic acids or anhydrides, polyisocyanates, ethylenically unsaturated compounds, or combinations thereof). For example, the self-emulsifying dispersion polymer can be prepared with polytetrahydrofuran, a carboxylic acid or anhydride, a polyol that is different from the polytetrahydrofuran, and another carboxylic acid or anhydride that is different from the first carboxylic acid or anhydride.

The amount of the polytetrahydrofuran may range from 20 to 90 wt. %, or from 40 to 80 wt. %, or from 50 to 70 wt. %, or from 80 to 90 wt. % of the reactants that form the self-emulsifying dispersion polymer. The amount of the carboxylic acid or anhydride can comprise an amount within a range such as from 5 to 20 wt. %, or from 8 to 18 wt. %, or from 10 to 16 wt. %, or from 14 to 16 wt. % of the reactants that form the self-emulsifying dispersion polymer.

The polymer film-forming resin of the present disclosure that is reactive with the melamine resin can have an acid value of at least 15, or at least 20, based on the total resin solids of the polymer. The polymer that is reactive with the melamine resin can have an acid value of up to 35 or up to 30, based on the total resin solids of the polymer. The polymer that is reactive with the melamine resin can have an acid value ranging from 15 to 35, or from 20 to 30, based on the total resin solids of the polymer.

The amount of the polymer film-forming resin reactive with the melamine resin can comprise at least 50 wt. %, at least 60 wt. %, or at least 70 wt. %, based on the total resin solids of the coating composition. The polymer reactive with the melamine resin can also comprise up to 90 wt. %, or up to 80 wt. %, based on the total resin solids of the coating composition. The polymer reactive with the melamine resin can further comprise an amount within a range such as from 50 to 90 wt. %, or from 60 to 80 wt. %, or from 70 to 80 wt. %, or from 70 to 90 wt. %, based on the total resin solids of the coating composition.

Suitable melamine resins for use as the co-reactive material of the present disclosure may be the resin obtained by addition-condensation of melamine with formaldehyde by methods known in the art, or by further addition-condensation of such resins with alcohols such as methanol, butanol or isobutanol. The imino and methylol functional groups together may comprise 30 mole % or greater, or 35 mole % or greater, or 40 mole % or greater, or 50 mole % or greater, or 55 mole % or greater, or 60 mole % or greater, or 70 mole % or greater, or 80 mole % or greater, or 90 mole % or greater, or up to 100 mole % of the total functionality of the melamine resin. The total amount of imino and methylol functional groups together may range, for example, from 30 to 80 mole %, or from 40 mole % to 80 mole %, or from 50 mole % to 70 mole %, based on the total functionality of the melamine resin.

The mole % of the functional groups on the melamine resin of the present disclosure can be determined by quantitative ¹³C-NMR, using a Bruker AVANCE™ II spectrometer operating at a carbon frequency of 75.48 MHz NMR, with dimethyl sulfoxide-d₆ (DMSO-d₆) as the NMR solvent and Cr(acac)₃ as a relaxation agent, which was recorded with relaxation times of 3 s, a pulse angle of 90 degrees, and an acquisition time of 0.66 s. In suitable melamines, the nitrogen atoms pendent from the triazine ring may be substituted by up to six functional groups. As used herein, any bridges to other triazine rings (often referred to as crosslinks) comprising a portion of the six functional groups on each triazine ring of the melamine resin are considered as functional groups for the sake of calculating the percentage functional groups on the melamine that are imino or methylol.

An example of a melamine resin is given in the structure below, wherein the triazine is substituted with one imino group (—NH), one methylol group (—CH₂OH), two methoxy groups (—CH₂OMe), one n-butoxy group (—CH₂OBu) and one isobutoxy group (—CH₂OisoBu). A fraction of the six functional groups on each triazine ring may be bridges to other triazine rings (often referred to as crosslinks). These bridges should be considered as functional groups for the sake of calculating the percentage functional groups on the melamine that are imino or methylol. Because the level of imino groups cannot be determined directly by ¹³C-NMR, one determines this level by evaluating the difference between the theoretical six functional groups per triazine ring and the level of other functional groups determined by quantitative ¹³C-NMR.

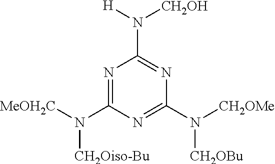

Examples of characteristic ¹³C-NMR peaks for typical substituents are 55 ppm (—OMe), 28ppm (iso-Bu), 90 ppm (bridge or crosslink), 13/31.5/64 ppm (-nBu). The carbon peak for —NCH₂OH shows up in the range of 66 to 70 ppm, and carbon peaks for —NCH₂OR shows up in the range of 70-79 ppm (where R includes an alkoxy group or a bridge group to another triazine ring). Further, —NCH₂OH/—NCH₂OR carbon peaks could be overlapping with substituent or solvent peaks. Peaks for iso-butanol solvent overlap with those of an —NCH₂OH carbon in the ¹³C NMR spectrum of RESIMENE™ HM 2608 melamine formaldehyde resin (INEOS, London, UK). Therefore, these peaks from substituents or solvents must be considered in calculating the mole % of imino groups or methylol groups. When using the ¹³C-NMR data to calculate the percentage of melamine functional groups that are imino or methylol, the triazine ring carbons (166 ppm) are normalized to equal 3. The mole % of NH and methylol are calculated from the peak intensities after normalizing the triazine ring carbons to 3. This calculation procedure is illustrated, below, for two melamines, RESIMENE™ HM 2608 melamine formaldehyde resin (INEOS) and CYMEL™ 202 melamine formaldehyde resin (Allnex, Frankfurt, DE), using the ¹³C-NMR obtained for these melamines.

Using the “melamine functional group mole % method”, the mole % of imino groups is calculated using the following Equation 1:

Mole % imino=100×(6−I_{—NCH2OR}−I_{—NCH2OH} )/6.

Further, the mole % of methylol groups is calculated by Equation 2:

Mole % methylol=100×(I_{—NCH2OH} )/6.

With respect to equations 1 and 2, R is an alkyl group and I_{—NCH2OR} is the peak intensity of —NCH₂OR carbons, as obtained by I_{—NCH2OR}=I_{(70-79 ppm)}−I_{-isoBu substituent (}28 ppm). Further, I_{—NCH2OH} is the peak intensity of —NCH₂OH carbons, as obtained by I_{—NCH2OH} =I₍66-70ppm)−I_{-nBu substituent (}31.5 ppm)−I_{-isoButanol (30.5 ppm)}.

For RESIMENE™ HM 2608 resin, the mole % calculation for imino using Equation 1 is illustrated as follows: Mole % imino=100×(6−I_{—NCH2OR}−I_{—NCH2OH} )/6=100×[6−(3.55−0.12)−(1.19−0.55]/6=32.2%. For RESIMENE™ HM 2608, the mole % calculation for methylol using Equation 2 is illustrated as follows: Mole % methylol =100×(I_{—NCH2OH} )/6=100×(0.64)/6=10.7%.

For CYMEL™ 202 resin, the mole % calculation for imino using Equation 1 is illustrated as follows: Mole % imino=100×(6−I_{—NCH2OR} −I_{—NCH2OH} )/6=100×[6−2.59−(1.93−1.23)]/6=45.2%. For CYMEL™ 202, resin, the mole % calculation for methylol using equation 2 is illustrated as follows: Mole % methylol=100×(I_{—NCH2OH} )/6=100×(0.7)/6=11.7%.

The aqueous coating compositions of the present disclosure may comprise (v) a composition of a keto functional polymer as the film-forming resin and a polyhydrazide or a hydrazide functional polymer as a co-reactive material. The keto functional polymer may comprise the addition polymerization product of a mixture ethylenically unsaturated compounds including from 2 to 30 wt. % of a multiethylenically unsaturated monomer and at least 30 wt. % of an aldo or keto group-containing ethylenically unsaturated monomer, based on the total weight of monomers used to make the polymer. Suitable ethylenically unsaturated compounds may include acrylic or vinyl monomers, such as alkyl esters of (meth)acrylic acid. Suitable multi-ethylenically unsaturated monomers may include as examples diethylenically or triethylenically unsaturated monomers, for example, divinyl aromatics like divinyl benzene; diacrylates and dimethacrylates of C₂-C₂₄ diols such as butane diol and hexane diol; divinyl ethylene urea and other divinyl ureas, and diallyl and triallyl compounds such as diallyl phthalate and triallyl isocyanurate. Suitable aldo or keto group-containing monomers may include as examples (meth)acrolein, diacetone (meth)acrylamide, acetoacetoxyethyl (meth)acrylate and vinyl acetoacetate. The polyhydrazide compounds may have two or more hydrazino groups (—NH—NH₂). Examples of these are maleic dihydrazide, fumaric dihydrazide, itaconic dihydrazide, phthalic dihydrazide, isophthalic dihydrazide, terephthalic dihydrazide, trimellitic trihydrazide, oxalic dihydrazide, adipic dihydrazide and sebacic dihydrazide. Polyhydrazide functional polymers may be made by post functionalizing an addition polymer or oligomer having carboxyl functional groups, such and oligomethacrylic acid with a polyhydrazide compound.

In accordance with the aqueous coating compositions of the present disclosure, the amount of the film-forming resin and the co-reactive component may range from 10 to 90 wt. %, based on the total solids of the aqueous coating composition, or, for example, from 12 to 80 wt. %, or, from 20 to 70 wt. %, or from 50 to 70 wt. %.

In accordance with the coating compositions of the present disclosure, suitable amounts of the co-reactive material may range from 1 to 50 wt. %, or from 1 to 30 wt. %, or from 2 to 30 wt. %, or from 5 to 40 wt. %, or from 20 to 30 wt. %, based on total resin solids.

In accordance with the present disclosure, coating compositions can contain rheology modifiers, such as a hydrophobically modified ethylene oxide urethane block copolymer (HEUR). The coating composition may include the rheology modifier in an amount of up to 20 wt. % of the total film-forming resin solids of a coating composition, or from 0.01 to 10 wt. %, or, from 0.05 to 5 wt. %, or, from 0.05 to 0.1, wt. %, based on the total weight of the coating composition.

Suitable HEURs may be a linear or branched HEUR formed by reacting a polyglycol, a hydrophobic alcohol, a diisocyanate, and a triisocyanate together in a one-pot reaction as in US 2009/0318595A1 to Steinmetz et al.; or those formed by polymerizing in a solvent-free melt, in the presence of a catalyst, such as bismuth octoate, of a polyisocyanate branching agent, a water-soluble polyalkylene glycol having an M_{w} (GPC using peg standards) of from 2000 to 11,000 Daltons, and a diisocyanate as in U.S. Pat. No. 9,150,683B2 to Bobsein et al.

In accordance with the present disclosure, the coating composition can also include fillers or extenders, such as barytes, talc and clays in amounts up to 70 wt. %, based on total weight of the coating composition.

In accordance with the present disclosure, the coating compositions can further comprise pigments or dyes as colorants. Suitable colorants can comprise any suitable pigment or dye. Exemplary pigments or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof. The coating compositions may comprise pigments in amounts of 20 to 70 wt. %, or from 30 to 50 wt. %, based on total weight of the aqueous coating composition. Non-limiting examples of suitable dyes include dioxazine carbazole violet, phthalocyanine blue, indanthrone blue, mono azo permanent orange, ferrite yellow, diarylide yellow, indolinone yellow, monoazo yellow, benzimidazolone yellow, isoindoline yellow, tetrachloroisoindoline yellow, disazo yellow, anthanthrone orange, quinacridone orange, benzimidazolone orange, phthalocyanine green, quinacridone red, azoic red, diketopyrrolopyrrole red, perylene red, scarlet or maroon, quinacridone violet, thioindigo red, and combinations thereof.

The coating composition in accordance with the present disclosure may include a functional pigment, such as, for example, a radar reflective pigment, LiDAR reflective pigment, corrosion inhibiting pigment, and combinations thereof. Suitable radar reflective or LiDAR reflective pigments may include, for example, nickel manganese ferrite blacks (Pigment Black 30), iron chromite brown-blacks and commercially available infrared reflective pigments. The LiDAR reflective pigment may be referred to as an infrared reflective pigment. The coating compositions may include LiDAR reflective pigment in an amount of from 0.1 wt. % to 5 wt. % based on a total weight of the coating composition.

The LiDAR reflective pigment can include a semiconductor and/or a dielectric (“SCD”) in which a metal is dispersed. The medium (e.g., SCD) in which the metal is dispersed may also be referred to herein as the matrix. The metal and matrix can form a non-homogenous mixture that can be used to form the pigment. The metal can be dispersed uniformly or non-uniformly throughout the matrix. The semiconductor of the LiDAR reflective pigment can include, as nonlimiting examples, silicon, germanium, silicon carbide, boron nitride, aluminum nitride, gallium nitride, silicon nitride, gallium arsenide, indium phosphide, indium nitride, indium arsenide, indium antimonide, zinc oxide, zinc sulfide, zinc telluride, tin sulfide, bismuth sulfide, nickel oxide, boron phosphide, titanium dioxide, barium titanate, iron oxide, doped version thereof (i.e., an addition of a dopant, such as, for example, boron, aluminum, gallium, indium, phosphorous, arsenic, antimony, germanium, nitrogen, at a weight percentage of 0.01% or less), alloyed versions of thereof, other semiconductors, or combinations thereof. As a nonlimiting example, the LiDAR reflective pigment can comprise silicon. The dielectric of the LiDAR reflective pigment can comprise solid insulator materials (e.g., silicon dioxide), ceramics (e.g., aluminum oxide, yttrium oxide, yttria alumina garnet (YAG), neodymium-doped YAG (Nd:YAG)), glass (e.g., borosilicate glass, soda lime silicate glass, phosphate glass), organic materials, doped versions thereof, other dielectrics, or combinations thereof. The organic material can comprise, for example, acrylics, alkyds, chlorinated polyether, diallyl phthalate, epoxies, epoxy-polyamid, phenolics, polyamide, polyimides, polyesters (e.g., PET), polyethylene, polymethyl methacrylate, polystyrene, polyurethanes, polyvinyl butyral, polyvinyl chloride (PVC), copolymer of PVC and vinyl, acetate, polyvinyl formal, polyvinylidene fluoride, polyxylylenes, silicones, nylons and co-polymers of nylons, polyamide-polymide, polyalkene, polytetrafluoroethylene, other polymers, or combinations thereof. If the dielectric comprises organic materials, the organic materials are selected such that the pigment formed therefrom is resistant to melting and/or resistant to changes in dimension or physical properties upon incorporation into a coating, film, and/or article formulation. The metal in the LiDAR reflective pigment can comprise, for example, aluminum, silver, copper, indium, tin, nickel, titanium, gold, iron, alloys thereof, or combinations thereof. The metal can be in particulate form and can have an average particle size in a range of 0.5 nm to 100 nm, such as, for example, 1 nm to 10 nm as measured by a transmission electron microscope (TEM). The metal can be in particulate form and can have an average particle size less than or equal to 20 nm as measured by TEM.

In accordance with the methods of the present disclosure, the aqueous coating compositions may contain a variety of conventional additives including, but not limited to, catalysts, including phosphonic acids, dispersants, surfactants, flow control agents, antioxidants, UV stabilizers and absorbers, surfactants, wetting agents, leveling agents, antifoaming or anti-gassing agents, anti-cratering agents, slip additives and adhesion promoters or combinations thereof.

Generally, both ionic and non-ionic surfactants may be used together and the amount of surfactant ranges from 1 to 10 wt. %, or from 2 to 4 wt. %, based on the total solids.

In accordance with the methods of the present disclosure, the aqueous coating compositions of the present disclosure may have a solids content ranging up to 25 wt. % or, alternatively up to 35%, or, alternatively up to 60 wt. %, or, alternatively up to 75 wt. % alternatively, up to 80 wt. %. The coating compositions of the present disclosure may have a solids content ranging 10 wt. % or greater, or, alternatively, 12 wt. %, or greater, or, alternatively, 15 wt. %, or greater, or, alternatively 20 wt. % or greater, based on the total weight of the coating compositions. The solids content of the aqueous coating compositions of the present disclosure may range from 10 to 80 wt. %, or from 12 to 75 wt. %, or from 12 to 60 wt. %, or from 12 to 35 wt. %, or from 15 to 35 wt. %, based on the total weight of the coating compositions.

In accordance with the methods of the present disclosure, two component aqueous coating compositions may be mixed just prior to applying them to a substrate by hand, or by feeding them separately into an in-line mixer or static mixer contained in or upstream of and feeding into a high transfer efficiency applicator.

In accordance with the methods of the present disclosure, the aqueous coating compositions of the present disclosure find use generally as basecoat, colorcoat or monocoat coating compositions, and in topcoat or clearcoat coating compositions to form a single layer coating or a multi-layer coating. The aqueous coating compositions of the present disclosure may also find use as primer or anti-corrosion coating compositions. Suitable aqueous topcoat coating and clearcoat coating compositions should be compatible with basecoat compositions; these can be the same as a pigmented basecoat coating composition but without the pigments.

In accordance with the methods of applying an aqueous coating composition to a substrate using a high transfer efficiency applicator, multi-layer coatings can include applying at least two coating compositions wherein applying one of the coating compositions comprises using a high transfer efficiency applicator to form one or more coating layers, which may be termed as “precisely applied coating layers”. The precisely applied coating layers of the resent disclosure may be any of a primer or anti-corrosion coating layer, a basecoat coating layer, a monocoat coating layer, a protective clearcoat coating layer, a topcoat coating layer or any combination of these.

In methods of making the precisely applied coating layers of the present disclosure, the precisely applied coating layer may be a basecoat coating composition or a monocoat coating composition, the methods comprising applying the coating composition to any of substrate, or any of a cured or uncured primer or anticorrosion coating layer, protective clearcoat coating layer, topcoat coating layer or another basecoat coating layer.

The methods of the present disclosure can comprise forming basecoat coating layer over at least a portion of a substrate by depositing a first basecoat composition onto at least a portion of a substrate using a high transfer efficiency applicator; and forming a second precisely applied basecoat layer over at least a portion of the first basecoat layer by depositing a second basecoat composition directly onto at least a portion of the first basecoat layer using a high transfer efficiency applicator before or after the first basecoat composition is dehydrated or cured.

In accordance with the present disclosure, each high transfer efficiency applicator may comprise a nozzle or valve containing device that has one or more nozzle openings or orifices that expel coating compositions as droplets or jets. Such devices may be, for example, a printhead containing one or more nozzles, or an applicator containing one or more nozzles or valves, such as a valve jet applicator. Each nozzle or valve containing device may be actuated via a piezo-electric, thermal, acoustic, or ultrasonic trigger or input, such as an ultrasonic spray applicator employing ultrasonic energy to an ultrasonic nozzle. Any suitable high transfer efficiency applicator or device for applying a coating composition may be configured to use in a continuous feed method, drop-on-demand method, or, selectively, both methods. Further, any suitable applicator device can be configured to apply a coating composition to a specific substrate, in a specific pattern, or both. Still further, the high transfer efficiency applicator can comprise any number of nozzles or valves which can be arranged to form a nozzle or valve assembly configured to apply a coating composition to a specific substrate, in a specific pattern, or both. Likewise, two or more separate high transfer efficiency applicators can be arranged to form a single assembly. Thus, the nozzles or valves of a high transfer efficiency applicator or set of multiple high transfer efficiency applicators in an assembly thereof, may have any configuration known in the art, such as linear, concave relative to the substrate, convex relative to the substrate, circular, or gaussian.

In accordance with the methods of the present disclosure, the one or more nozzles or valves of the high transfer efficiency applicator may have a nozzle opening having a diameter of from 20 to 400 microns, such as from 30 to 340 microns. The droplets or jets expelled from the nozzle opening each may have a diameter of from 20 to 400 microns, or for example, from 30 to 340 microns.

In accordance with the present disclosure, suitable substrates may comprise those known in the art, such as a vehicle, including an automobile, or aircraft and packaging substrates such as beverage and food cans. The substrates may include a metal-containing material, a plastic-containing material, or a combination thereof, such as a non-porous substrate. Various substrates may include two or more discrete portions of different materials. For example, vehicles can include metal-containing body portions and plastic-containing trim portions. Due to the bake temperature limitations of plastics relative to metals, the metal-containing body portions and the plastic-containing trim portions may be conventionally coated in separate facilities thereby increasing the likelihood for mismatched coated parts. Alternatively, where cure and handling conditions permit, the metal-containing substrate may be coupled to the plastic-containing substrate.

### EXAMPLES

The following examples are used to illustrate the present disclosure without limiting it to those examples. Unless otherwise indicated, all temperatures are 22° C., all pressures are 1 atmosphere and relative humidity was 30%. Notwithstanding that the numerical ranges and parameters setting forth the broad scope of the disclosure are approximations, numerical values set forth in the specific examples are reported as precisely as possible. Any numerical value inherently contains certain errors necessarily resulting from the standard variation found in their respective testing measurements. The materials used in the Examples, below, are set forth in Table 1, below.

In Table 1, below, the comparative one component melamine containing crosslinking aqueous coating composition of Comparative Example 1 was formed by mixing the aqueous phase ingredients under stirring for a period of 20 minutes or until readily mixed. The organic phase ingredients were then mixed under stirring for 15 minutes prior to being added into the aqueous phase mixture. After mixing the aqueous and organic phase ingredients, the coating composition was allowed to stand overnight. The pH was then adjusted to 8.6 using 50% dimethylethanolamine and then water was added to adjust the viscosity to 90 cP as measured by BYK CAP 2000+ Viscometer with Spindle #4 at a shear rate of 1000 s⁻¹ at 20° C. The solids content of the composition was 33.4%.

In Table 1, below, the two-component low temperature curing aqueous coating composition of Example 2 was prepared by slowly adding the ingredients listed in the Table into a stirring/mixing vessel during mixing. 100 parts by weight (pbw) of this composition was thoroughly mixed with 15.8 pbw of an isocyanate functional co-reactive component immediately prior to use. The co-reactive component was prepared from 14.76 pbw of dipropylene glycol dimethyl ether (PROGLYDE™ DMM polyol, Dow Chemical, Midland MI), 13.16 parts by weight of xylene, 30.71 parts by weight of BAYHYDUR™ 401-70 polyisocyanate (hydrophilically modified aliphatic polyisocyanate based on isophorone diisocyanate, Covestro, Pittsburgh, PA) and 23.37 parts by weight of BAYHYDUR™ 302 polyisocyanate (water-dispersible polyisocyanate made from an hexamethylene diisocyanate, Covestro). The co-reactive component has greater than 5 wt. % of free polyisocyanate and a weight average molecular weight of less than 600 g/mol.

TABLE 1
Coating Compositions

| | EXAMPLE | | |
|---|---|---|---|
| Aqueous phase ingredients | 1* | 2 | 3 |
| Deionized Water | 1.17 | 89.44 | 12.30 |
| Latex A ¹ | 36.82 | | |
| Latex B ² | 46.62 | | |
| Latex C ¹⁶ | | 152.60 | |
| Latex D ¹⁹ | | | 891.19 |
| Polyester A ³ | 102.93 | | 99.01 |
| Polyester B ⁴ | 7.10 | | |
| Adipic acid dihydrazide | | | 2.97 |
| Waterborne carbodiimide crosslinker | | | 104.53 |
| with a hydrophilic segment ²⁰ | | | |
| 50% w/w aqueous dimethylethanolamine | 1.19 | 2.18 | |
| Surfactant⁵ | 0.23 | 0.29 | 0.51 |
| Defoamer⁶ | 1.96 | 1.76 | 3.98 |
| Nonionic Surfactant ⁷ | 5.04 | 3.82 | 8.20 |
| Polypropylene glycol ⁸ | 2.53 | | |
| Defoamer⁹ | 10.08 | | |
| Black tint ¹⁰ | 75.61 | 38.79 | 131.95 |
| White tint¹⁷ | | 60.79 | 68.27 |
| Extender tint²¹ | | | 99.22 |
| Urethane diol¹⁸ | | 5.74 | |
| Propylene glycol n-butyl ether ¹¹ | 8.73 | 2.87 | |
| Laponite solution ¹² | 93.27 | | |
| Polyurethane-acrylic dispersion¹⁵ | | 122.20 | |
| Deionized Water | | 89.44 | 18.45 |
| Organic phase ingredients | (mixed | (not mixed | |
| | separately) | separately) | |
| Melamine A¹³ | 34.92 | | |
| 2-ethylhexanol | 4.93 | 6.69 | |
| Odorless mineral spirits¹⁴ | 17.14 | 2.87 | 30.74 |
| Propylene glycol n-butyl ether ¹¹ | 21.82 | | 20.50 |
| 50% DMEA | | 1.35 | |
| Defoamer⁹ | | 7.40 | |
| Initial Solids % (wt. %) | 33.4 | 32.0 | 35.2 |

*Denotes Comparative Example;
¹ Core/shell urethane and hydroxyl functional acrylic latex polymer microparticles as disclosed in US 2015/0210883 A1 to Swarup et al., Example G part 1 and part 2. The volume average latex particle size was 130 nm; the solids content was 38.2 wt. %;
² Hydroxyl functional core/shell acrylic latex as disclosed in US 2015/0210883 A1 to Swarup et al., Example A. The volume average latex particle size was 140 nm; the solids content was 25.0 wt. %;
³ Waterborne polyester as described in US 2015/0210883 A1 to Swarup et al., Example H;
⁴ Hydroxy functional polyester as disclosed in US 6291564 to Faler et al., Example 1; the solids content was 80.3 wt. %;
⁵BYK ™ 348 silicone surfactant (Byk Chemie, Wallingford, CT);
⁶BYK ™ 032 P Emulsion of paraffin-containing mineral oils (Byk Chemie, Wallingford, CT);
⁷ SURFYNOL 104E Nonionic Surfactant (Air Products and Chemicals, Allentown, PA);
⁸ Polypropylene glycol, number average molecular weight 1000 (The Dow Chemical Company, Midland, MI);
⁹BYKETOL ™ WS defoamer (Byk Chemie, Wallingford, CT);
¹⁰ 36Black tint paste includes 6% carbon black (MONARCH ™ 1300, Cabot Corp, Boston, MA) dispersed in 17 wt. % acrylic polymer blend and having a solids content of 24 wt. %;
¹¹ DOWANOL ™ PnB solvent (The Dow Chemical Co., Midland, MI);
¹² A 2 wt. % aqueous solution of LAPONITE ™ RD layered silicate (Southern Clay Products, Gonzales, TX);
¹³Methylated melamine curing agent RESIMENE ™ HM-2608 resin (Prefere Resins Holding GmbH, Erkner, DE);
¹⁴Shell Chemical Co. (Deer Park, TX);
¹⁵Polyurethane-acrylic aqueous dispersion made of 9.73 wt % adipic acid, 11.30 wt % isophthalic acid, 2.15 wt % maleic anhydride, 21.66 wt % 1,6-hexanediol, 5.95 wt % dimethylolpropionic acid, 1.0 wt. % butanediol, 16.07 wt % isophorone diisocyanate, 26.65 wt % butyl acrylate, 2.74 wt % hydroxypropyl methacrylate and 2.74 wt % ethylene glycol dimethacrylate, with a solids content 45 wt % in deionized water. The volume average particle size was 130 nm;
¹⁶ Acrylic polymeric core-shell latex in which: the core was made of 65.1 wt. % methyl methacrylate, 27.1 wt. % butyl acrylate, 5.3 wt. % hydroxyethyl methacrylate, 2.4 wt. % ethylene glycol dimethacrylate, 0.1 wt. % methacrylate acid; and the shell was made of 36.4 wt. % butyl acrylate, 22.7 wt. % methacrylate acid, 16.7 wt. % methyl methacrylate and 24.2 wt. % hydroxyethyl acrylate, the shell/core weight ratio was 87/13. The polymeric core-shell latex has a solids content of 25 wt. % in deionized water;
¹⁷White tint paste formed from 61 wt. % TiO₂ dispersed in 9 wt. % acrylic polymer blend having a solids content of 70 wt. %;
¹⁸Polyurethane diol prepared by reacting 1 mole of JEFFAMINE D-400 polyetheramine (Huntsman Chemical Co., Salt Lake City, UT) with 2 moles of ethylene carbonate at 130° C. as disclosed in Example A of U.S. Pat. No. 7,288,595 to Swarup et al.;
¹⁹ Keto functional core/shell urethane acrylic latex as described in WO 2017/160398 A1 to Xu et al., Example 3; solid content of 38.6% and an average particle size of 60 nm (ZETASIZER 3000HS following the manufacturer's instructions);
²⁰ CARBODILITE V-02-L2 Waterborne carbodiimide crosslinker (GSI Exim America, Inc., New York, NY);
²¹Extender tint paste includes 61 wt. % barium sulfate dispersed in 10 wt. % acrylic polymer and having a solids content of 71 wt. %.

The two-component coating composition of Example 2 had a pH of 9.1, a coatings solids content of 32 wt. % and a viscosity of 90 cp as measured by BYK CAP 2000+ Viscometer with Spindle #4 at a shear rate of 1000 s−1 at 20° C.

In Table 1, above, the one-component low temperature curing aqueous coating composition of Comparative Example 3 was prepared by slowly adding the listed ingredients into a stirred mixing vessel. After mixing the coating composition was allowed to stand overnight. The pH was then adjusted to 8.7 using 50% dimethylethanolamine and then water was added to adjust the viscosity to 80 cP as measured by BYK CAP 2000+ Viscometer with Spindle #4 at a shear rate of 1000 s−1 at 20° C. The solids content of the composition was 35.2%.

Dehydration Time Evaluation: Each of the aqueous pigmented basecoat coating compositions was applied over a 10.24 cm×30.72 cm (4 inch by 12 inch) steel panel that had been pre-coated with an ED6465 electrocoat (PPG Industries, Pittsburgh, PA). The basecoat compositions were applied to the pre-coated steel panel by drawdown under controlled environmental conditions of 23° C. (75° F.) and 60% relative humidity. Two coats of each basecoat were applied with a 5-minute flash period in-between. The dry film build of the final coating was approximately 35 μm.

The foil solids (fs) for each indicated coating composition in Table 2, below, was determined by weighing a foil prior to application of the coating composition (initial foil weight (ifw)). The weight of the foil immediately after the coating application and the flash periods was then recorded (wet foil weight, wfw). Finally, the foil was baked at 110° C. for one hour and the weight was recorded again (dry foil weight, dfw). The foil solids of each coating was determined after dehydration.

The % Loss of volatiles compares final volatiles to initial volatiles or (1−(initial solids (is)), wherein initial solids are the total solid content of the indicated coating composition in wt. % divided by 100. The coating compositions were applied to a foil sheet attached to a coating panel; and the applied coating layers were dehydrated in an oven with airflow and humidity control under the conditions indicated in Table 2, below. The foil solids of each coating was determined after dehydration, with the weight percent of foil solids for each coating composition was determined by measuring the non-volatile coating content deposited on a 75 mm by 100 mm pre-weighed foil sheet attached to each panel. The foil was removed from the panel after the drying process and weighed, then baked until nonvolatiles only were present at a temperature of 110° C.

As shown in Table 2, below, the aqueous coating compositions of the present disclosure exhibit a dramatic improvement in dehydration rate when drying and baking in a variety of humidity and air flow conditions.

TABLE 2
Rapid Dehydration (at 65° C.) Test Results

| | | | | Initial | Wet | Dry | | |
|---|---|---|---|---|---|---|---|---|
| | Oven | Oven | Dehydration | foil | foil | foil | Foil | % loss of |
| | Humidity | Airflow | Time | weight | weight | weight | solids¹ | volatiles² |
| Example | (g/m³) | (m/min) | (min) | (g) | (g) | (g) | (wt. %) | (wt. %) |
| 1 | 7 | 152.4 | 2 | 0.853 | 1.457 | 1.177 | 53.64% | 56.60% |
| 1* | 7 | 152.4 | 4 | 0.857 | 1.267 | 1.17 | 76.34% | 84.46% |
| 1* | 7 | 274.3 | 2 | 0.852 | 1.191 | 1.073 | 65.19% | 73.22% |
| 1* | 7 | 274.3 | 4 | 0.852 | 1.131 | 1.081 | 82.08% | 89.05% |
| 1* | 25 | 152.4 | 2 | 0.849 | 1.449 | 1.15 | 50.17% | 50.19% |
| 1* | 25 | 152.4 | 4 | 0.851 | 1.339 | 1.183 | 68.03% | 76.43% |
| 1* | 25 | 274.3 | 2 | 0.852 | 1.278 | 1.072 | 51.64% | 53.04% |
| 1* | 25 | 274.3 | 4 | 0.848 | 1.184 | 1.096 | 73.81% | 82.21% |
| 2 | 7 | 152.4 | 2 | 0.852 | 1.273 | 1.196 | 81.71% | 89.47% |
| 2 | 7 | 152.4 | 4 | 0.858 | 1.229 | 1.199 | 91.91% | 95.86% |
| 2 | 7 | 274.3 | 2 | 0.855 | 1.259 | 1.2 | 85.40% | 91.95% |
| 2 | 7 | 274.3 | 4 | 0.853 | 1.242 | 1.218 | 93.83% | 96.91% |
| 2 | 25 | 152.4 | 2 | 0.863 | 1.162 | 1.104 | 80.60% | 88.67% |
| 2 | 25 | 152.4 | 4 | 0.866 | 1.131 | 1.109 | 91.70% | 95.74% |
| 2 | 25 | 274.3 | 2 | 0.864 | 1.263 | 1.202 | 84.71% | 91.51% |
| 2 | 25 | 274.3 | 4 | 0.866 | 1.241 | 1.212 | 92.27% | 96.06% |
| 3 | 7 | 152.4 | 2 | 0.831 | 1.085 | 1.061 | 90.55% | 94.33% |
| 3 | 7 | 152.4 | 4 | 0.834 | 1.106 | 1.092 | 94.85% | 97.05% |
| 3 | 7 | 274.3 | 2 | 0.856 | 1.244 | 1.199 | 88.40% | 92.87% |
| 3 | 7 | 274.3 | 4 | 0.854 | 1.181 | 1.163 | 94.50% | 96.84% |
| 3 | 25 | 152.4 | 2 | 0.856 | 1.222 | 1.171 | 86.07% | 91.21% |
| 3 | 25 | 152.4 | 4 | 0.858 | 1.174 | 1.155 | 93.99% | 96.53% |
| 3 | 25 | 274.3 | 2 | 0.855 | 1.241 | 1.179 | 83.94% | 89.61% |
| 3 | 25 | 274.3 | 4 | 0.853 | 1.191 | 1.173 | 94.67% | 96.94% |

*Denotes Comparative Example;
¹% Foil solids (fs) = (dfw − ifw)/(wfw − ifw);
²% loss of volatiles = ((1 − is) − ((1 − fs)*(is/fs)))/(1 − is) X 100%, where is = Initial application solids from Table 1 divided by 100%.

Sag evaluation: 2 different water based black paints were drawn down using an anti-sag meter (4-24 mils) from BYK Instruments. The vertical sag fail was determined as the paint stripe (and corresponding wet film thickness) that closes the gap with the next lower stripe, as according to ASTM D4400-18. As shown in Table 3, the low temperature cure paint of Example 2 from Table 1 loses water and solvent at a faster rate than the control paint, which results in a faster viscosity build and therefore allows a higher film build before sag failure occurs.

TABLE 3
% volatile loss and sag resistance

| Paint | % volatile loss (4′ Room T) | Sag fail |
|---|---|---|
| Example 2 | 15.2% | >24 mils |
| JetBlack control* | 7.7% | 20 mils |

*Available as JetBlack code BIPCU668 from PPG Industries, Inc.

Whereas the particulars of the present disclosure have been described above for purposes of illustration, it will be evident to those skilled in the art that numerous variations of the details of the present disclosure may be made without departing from the invention as defined in the appended claims.

1. A method of forming a coating layer on a substrate comprising:
a) applying an aqueous coating composition to at least a portion of the substrate using a high transfer efficiency applicator that expels the coating composition; and
b) curing the coating composition to form a cured coating layer;
wherein the aqueous coating composition comprises
an aqueous carrier,
a film-forming resin having at least one crosslinking-functional group, and
a co-reactive material having at least one functional group reactive with the crosslinking-functional group;
wherein the cured coating layer of the aqueous coating composition achieves 100 MEK double rubs as measured in accordance with ASTM D5402-19 (2019) after baking at 80° C. for 30 minutes at a coating thickness of 35 μm.

2. The method as claimed in claim 1, wherein the uncured coating layer achieves at least a 60 wt. % loss of volatiles, as compared to the volatiles content of the aqueous coating composition prior to application, when applied to a metal foil at a coating thickness of 35 μm after a 10 minute dehydration period under conditions of 23° C. and 101.3 kPa (1 atm), and then baking for 2 minutes at 65° C.

3. The method as claimed in claim 1, wherein the aqueous coating composition comprises a one-component composition.

4. The method as claimed in claim 1, wherein the aqueous coating composition comprises a multi-component composition in which a first component comprises the film-forming resin and a second component comprises the co-reactive material;
wherein a ratio of the viscosity of the first component to the viscosity of the second component as measured by BYK CAP 2000+ Viscometer with Spindle #4 at a shear rate of 1000 s−1 at 25° C. ranges from 2:1 to 1:2; and
optionally wherein one component comprises an aqueous dispersion of a hydroxyl functional material as the film-forming resin and another component comprises an aqueous dispersion of an isocyanate functional material as the co-reactive material; and
optionally wherein one component comprises a carboxyl functional material as the film-forming resin and another component comprises a carbodiimide functional material as the co-reactive material; and
wherein one component comprises a carboxyl functional material as the film-forming resin and a carbodiimide functional material as the co-reactive material; and
optionally wherein one component comprises a polymer as the film-forming resin having an acid value of at least 15 obtained from greater than 20 wt. % of a polytetrahydrofuran and greater than 5 wt. % of a carboxylic acid or anhydride, based on the weight of reactants used to form the polymer, and another component comprises a melamine resin as the co-reactive material comprising imino and methylol functional groups that together comprise 30 mole % or greater of the total functionality of the melamine resin; and
optionally wherein one component comprises a keto functional polymer as the film-forming resin and another component comprises a polyhydrazide or a hydrazide functional polymer as the co-reactive material; and
optionally wherein one component comprises a hydroxyl functional material as the film-forming component resin and another component comprises an isocyanate functional material having a weight average molecular weight of less than 600 g/mol and containing greater than 5 wt. % of free polyisocyanate as the co-reactive material.

5. (canceled)

6. The method as claimed in claim 1, wherein the aqueous coating composition has a rheology profile at 25° C. and a pressure of 101.3 kPa (1 atm) defined as the ratio of the viscosity at a shear rate of 0.1 s⁻¹ to the viscosity at a shear rate of 1000 s⁻¹ of from 25:1 to 350:1, as measured using a BYK CAP 2000+ Viscometer with Spindle #4.

7-14. (canceled)

15. The method as claimed in claim 1, wherein the aqueous coating composition comprises from 1 to 30 wt. %, based on total coating composition solids of a polyester film-forming resin in addition to the film-forming resin having at least one crosslinking-functional group.

16. The method as claimed in claim 1, wherein the aqueous coating composition comprises a rheology modifier wherein the rheology modifier comprises an inorganic thixotropic agent, an acrylic alkali swellable emulsion (ASE), a hydrophobically-modified alkali swellable emulsion (HASE), a hydrophobically modified ethylene oxide urethane block copolymer (HEUR), an associative thickener other than a HEUR, hydrophobically-modified hydroxy ethyl cellulose (HMHEC), cellulosic thickeners other then HMHEC, polyvinyl alcohol, polyvinyl pyrrolidone, polyvinyl methylether, polyethylene oxide, polyacrylamide, ethylene vinyl acetate, polyamide, polyacrylic acid, mixtures thereof, or combinations thereof; and/or
a swelling solvent that causes at least part of the film-forming resin to swell and expand prior to cure comprising an alkyl ether, glycol ether, hydrophobic group containing alcohol, hydrophobic group containing ketone, alkyl ester, alkyl phosphate and mixtures thereof.

17-22. (canceled)

23. The method as claimed in claim 1, wherein the high transfer efficiency applicator has one or more nozzles or valves having an orifice that expels the aqueous coating composition in droplets or jets and an opening diameter ranging from 20 to 400 microns;
wherein the expelled droplets or jets each have a diameter of from 20 to 400 microns; and
optionally wherein the high transfer efficiency applicator has a nozzle with at least one orifice and each orifice discharges the coating composition to form a jet having the form of an essentially two-dimensional line segment, an essentially planar lamina, a hollow cylindrical jet; and optionally wherein the applicator has more than one nozzle and the nozzles cooperatively discharge the coating composition to form a liquid sheet.

24-25. (canceled)

26. The method as claimed in claim 1, wherein the substrate has a vertical portion, and the coating layer is formed on the vertical portion of the substrate.

27. The method as claimed in claim 1, wherein the high transfer efficiency applicator comprises a valve jet applicator having one or more nozzle openings, each of which discharges the aqueous coating composition in the form of a coherent coating composition jet or in the form of a droplet.

28. The method as claimed in claim 1, wherein the method further comprises applying a primer layer on the substrate prior to applying a pigmented basecoat coating composition to at least a portion of the substrate using a high transfer efficiency applicator; and/or
wherein the method comprises forming a clearcoat coating layer by applying a clearcoat coating composition over at least a portion of the pigmented basecoat layer applied using a high transfer efficiency applicator; and/or
wherein the substrate is not masked with a removable material prior to applying the aqueous coating composition.

29-32. (canceled)

33. A substrate coated by the method as claimed in claim 1; and
optionally wherein the substrate is a vehicle, a packaging substrate, or a part thereof; and/or
wherein the coating layer is formed on a portion of the substrate that defines a target area having a discrete boundary outside of which the substrate does not have the coating layer; and/or
wherein the substrate has a vertical portion, and the coating layer is formed on the vertical portion of the substrate.

34-36. (canceled)

37. An aqueous coating composition comprising a two-component composition wherein one component comprises an aqueous dispersion of a hydroxyl functional material and the other component comprises an aqueous dispersion of an isocyanate functional material; and/or
wherein one component comprises a carboxyl functional material and the other component comprises a carbodiimide functional material; and/or
wherein one component comprises a hydroxyl functional material and the other component comprises an isocyanate functional material having a weight average molecular weight of less than 600 g/mol and containing greater than 5 wt. % of free polyisocyanate.

38-39. (canceled)

40. An aqueous coating composition comprising a one component composition comprising a carboxyl functional material and a carbodiimide functional material; and/or
wherein the aqueous coating composition comprising a one component composition comprises a polymer having an acid value of at least 15 obtained from greater than 20 wt. % of a polytetrahydrofuran and greater than 5 wt. % of a carboxylic acid or anhydride, based on the weight of reactants used to form the polymer, and a melamine resin comprising imino and methylol functional groups that together comprise 30 mole % or greater of the total functionality of the melamine resin; and/or
wherein the aqueous coating composition comprises a one component composition comprising a keto functional polymer and a polyhydrazide or a hydrazide functional polymer; and
optionally wherein the aqueous coating composition comprises from 1 to 30 wt. %, based on total coating composition solids of a polyester film-forming resin.

41-44. (canceled)

45. The aqueous coating composition according to claim 40, wherein the aqueous coating composition comprises a rheology modifier;
wherein the rheology modifier comprises an inorganic thixotropic agent, an acrylic alkali swellable emulsion (ASE), a hydrophobically-modified alkali swellable emulsion (HASE), a hydrophobically modified ethylene oxide urethane block copolymer (HEUR), an associative thickener other than a HEUR, hydrophobically-modified hydroxy ethyl cellulose (HMHEC), cellulosic thickeners other then HMHEC, polyvinyl alcohol, polyvinyl pyrrolidone, polyvinyl methylether, polyethylene oxide, polyacrylamide, ethylene vinyl acetate copolymer, polyamide, polyacrylic acid, mixtures thereof, or combinations thereof; and/or
wherein the aqueous coating composition comprises a swelling solvent that causes at least part of the film-forming resin to swell and expand prior to cure;
wherein the swelling solvents comprise alkyl ether, glycol ether, hydrophobic group containing alcohol, hydrophobic group containing ketone, alkyl ester, alkyl phosphate and mixtures thereof.

46-50. (canceled)

51. The aqueous coating composition according to claim 37, wherein the solids content of the aqueous coating composition ranges from 10 to 80 wt. % based on the total weight of the coating composition.

52. (canceled)

53. The aqueous coating composition according to claim 40, wherein the solids content of the aqueous coating composition ranges from 10 to 80 wt. % based on the total weight of the coating composition.
